(19) United States
(12) Patent Application Publication
(10) Pub. No.: US 2015/0240118 A1
(43) Pub. Date: Aug. 27, 2015

(54) GRAPHENE COMPOSITE COATING LAYER

(71) Applicant: Enerage Inc., Wujie Township (TW)

(72) Inventors: Mark Y. WU, Wujie Township (TW); Cheng-Yu HSIEH, Wujie Township (TW); Chen-Kai SHUI, Wujie Township (TW)

(73) Assignee: Enerage Inc., Wujie Township (TW)

(21) Appl. No.: 14/268,301

(22) Filed: May 2, 2014

(30) Foreign Application Priority Data
Feb. 24, 2014 (TW) 103106104

(51) Int. Cl. C09D 179/04; C08K 9/04

(52) U.S. Cl. CPC C09D 179/04; C08K 9/04

(57) ABSTRACT

A graphene composite coating layer for being coated on the surface of the target object comprises a curable mixed resin more than 97 wt % and a plurality of surface modified nano graphene sheets. The curable mixed resin comprises a curable resin and a curing agent. The curable resin is 10-50 wt % of the curable mixed resin, and the curing agent is 0˜10 wt % of the curable mixed resin. The surface modified graphene sheets with less than 3 wt % of the graphene composite coating layer are evenly spread in the curable mixed resin. The surface of the surface modified nano graphene sheet has some specific functional groups to form effective bonding with the curable mixed resin, thereby improving the compatibility of the surface modified nano graphene sheets and the curable mixed resin, increasing the junction strength, and enhancing the functions like anti-oxidation, acid/base resistance and mechanical strength.

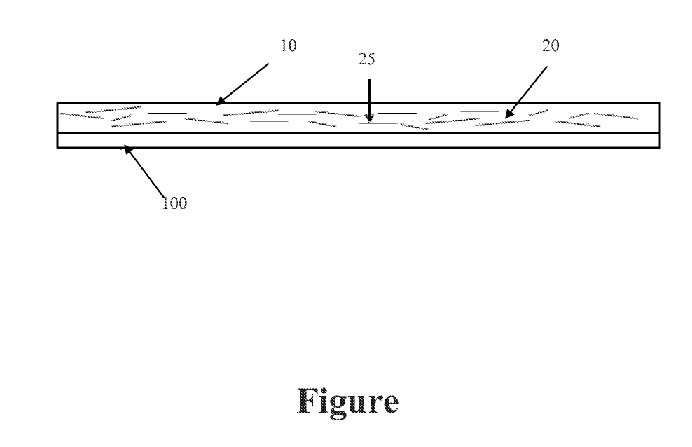

### CROSS-REFERENCE TO RELATED APPLICATION

This application claims the priority of Taiwanese patent application No. 103106104, filed on Feb. 24, 2014, which is incorporated herewith by reference.

### BACKGROUND OF THE INVENTION

1. Field of the Invention

The present invention generally relates to a graphene composite coating layer, and more specifically to a graphene composite coating layer comprising surface modified nano graphene sheets with specifically modified surface well mixed with a curable resin to enhance surface strength so as to serve as an enhanced coating layer coated on a target substrate material to increase the properties of anti-oxidation, resistance to acid and base, and mechanical strength.

2. The Prior Arts

In general, graphene is an excellent material constructed by two-dimensional crystal bonded with sp² hybrid orbital in a form of hexagonal honeycomb. The thickness is about only one carbon diameter, that is, 0.335 nm. It is believed that graphene is the thinnest material in the world. In particular, its mechanical strength is larger than steel by one hundred times more, and its specific gravity is only one fourth of steel. To enhance the mechanical properties of the current composite materials, graphene is certainly the best option.

The traditional methods for manufacturing graphene are basically classified into three groups, including peeling off graphite, direct growth and carbon nanotube conversion. In particular, the method of peeling off graphite capable of obtaining graphene powder is mainly implemented by chemical oxidation-reduction for mass production. Specifically, graphite is first oxidized to form oxidized graphene, which is an oxidized form of graphene and contains extremely high content of oxygen atoms or other functional groups on the surface and in the bulk thereof. Such oxidized graphene is helpful to disperse oxidized graphene in the solution. However, the sp² hybrid orbital structure is easily destroyed, and the open ring, 5 carbons ring or 7 carbons ring are possibly formed on the surface, leading to serious deterioration of crucial physical properties, even worse than normal graphite.

Subsequently, oxidized graphene is reduced to reduce oxidized graphene by thermal treatment or chemical reduction. The functional groups on the surface are thus greatly decreased after the above process, resulting in thin flakes with the two dimensional structure. This step is useful to recover the original physical properties of graphene. However, when graphene is needed to combine with another material, the junction adhesion is much weaker due to the heterojunction formed between the two different materials.

Various resins with excellent properties like strong adhesion, acid/base resistance and electrical insulation are applied to adhesive, paint, insulative material and composite material. Traditionally, composite material possessing higher strength and low density has become one of indispensable engineering materials. The solid form of composite material particularly provides many properties such as strong adhesion, good electrical insulation, chemical stability and low shrinkage, and is thus broadly applicable to various fields.

In the prior arts, CN 102286189 disclosed a composite material formed of oxidized graphite and epoxy resin. Specifically, oxidized graphite and epoxy resin are first mixed by one of conventional mixing means, and then the mixture is solidified to form an intermediate product for improving mechanical strength of epoxy resin. The process is indeed free of toxic solvent and helpful to disperse graphene. However, oxidized graphite contains too many functional groups helpful to combine with another material, poor mechanical properties resulted in are worse than traditional graphite.

WO 2011120008 disclosed a composite material formed of graphene and dimethylacetamide resin, in which chemical reduced graphene is mixed with dimethylacetamide resin, and then the mixture is solidified to form a solid product with improved mechanical performance for epoxy resin. However, the functional groups on the surface of chemical reduced graphene are quite fewer and fail to combine with epoxy resin to form the effective junction.

Therefore, it is greatly needed for the surface modified nano graphene sheets with specifically modified surface possessing some functional groups compatible with the functional groups of the resin such that the surface modified nano graphene sheets are well combined with the resin to form the composite material, thereby increasing the strength of the junction and effectively improving the mechanical property of the resultant composite material.

### SUMMARY OF THE INVENTION

The primary objective of the present invention is to provide a graphene composite coating layer for being coated on a surface of a target object. The graphene composite coating layer of the present invention generally comprises a curable mixed resin and a plurality of surface modified nano graphene sheets. The curable mixed resin is more than 97 wt % of the graphene composite coating layer and comprises a curable resin and a curing agent. The curable resin is 10-50 wt % of the curable mixed resin, and the curing agent is 0˜10 wt % of the curable mixed resin. The surface modified nano graphene sheets are evenly spread in the curable mixed resin, and less than 3 wt % of the graphene composite coating layer. The distribution density of the surface modified nano graphene sheets is 0.001-0.05 g/cm³.

Specifically, the surface modified nano graphene sheet has a surface modified by some specific functional groups, comprising at least one of —SO₃, —R′COX, —R′(COOH)₂, —R′COOH, —R′CH₂X—OH and —R′CHO, wherein R′ is alkyl, and X is —NH₂ and/or OH. The functional groups on the surface help the surface modified nano graphene sheets and the curable resin effectively form chemical bonds such that the compatibility of the surface modified nano graphene sheets and the curable resin is greatly enhanced.

The curable resin has some advantages like excellent chemical stability and high mechanical strength, and thus the chemical stability and mechanical strength of the target object are improved. The curable resin and the curing agent are processed by a crosslink reaction at a temperature of 150-250° C. A catalyst for speeding up the crosslink reaction is further included such that the change in viscosity of the curable resin does not affect the homogeneousness of the surface modified nano graphene sheets spread in the curable mixed resin when the heated crosslink reaction is activated.

Therefore, the graphene sheets with the modified surface is fully and compatibly mixed with the resin, and thus evenly spread in the resin. As a result, the adhesion strength of the junction is increased and the mechanical strength is effectively improved. The graphene composite coating layer of the present invention is suitably served as an enhancing coating layer for the target object, thereby enhancing the functions of the target object like anti-oxidation, acid/base resistance and mechanical strength.

### BRIEF DESCRIPTION OF THE DRAWINGS

The present invention can be understood in more detail by reading the subsequent detailed description in conjunction with the examples and references made to the accompanying drawings, wherein:

FIGURE is a sectional view schematically showing the graphene composite coating layer according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

Please refer to FIGURE showing the graphene composite coating layer according to the present invention. As shown in FIGURE, the graphene composite coating layer 10 according to the present invention is coated on a surface 100 of a target object generally, and generally comprises a curable mixed resin 20 and a plurality of surface modified nano graphene sheets 25. The curable mixed resin 20 is more than 97 wt % of the graphene composite coating layer 10, and comprises a curable resin and a curing agent. Specifically, the curable resin is 10-50 wt % of the curable mixed resin, and the curing agent is 0˜10 wt % of the curable mixed resin.

The surface modified nano graphene sheets 25 are evenly spread in the curable mixed resin 20, and less than 3 wt % of the graphene composite coating layer 10 with a distribution density of 0.001-0.05 g/cm³. More specifically, the surface modified nano graphene sheets 25 are formed by modifying the surface of the nano graphene sheets so as to have some specific function groups, comprising at least one of —SO₃, —R′COX, —R′(COOH)₂, —R′COOH, —R′CH₂X—OH and —R′CHO, wherein R′ is alkyl, and X is —NH₂ and/or OH. The oxygen content in the surface modified nano graphene sheets 25 is preferably 3-20 wt %. It is believed that the functional groups on the surface help the surface modified nano graphene sheets 25 and the curable resin effectively form chemical bonds such that the compatibility of the surface modified nano graphene sheets 25 and the curable resin is greatly enhanced.

The curable resin comprises at least one of epoxy resin, polybenzoxazine, polyurethane resin, polysiloxane, phenoic resin, acrylic resin, urea formaldehyde resin and polyester, so as to possess some advantages like excellent chemical stability and high mechanical strength. Thus, the chemical stability and mechanical strength of the target object are improved. The curing agent comprises at least one of diethylmethylbenzenediamine (DETDA), polyamide hardener, peptide, aliphatic amine epoxy hardener, methylhexahydrophthalic anhydride (MHHPA) and methyltetrahydrophthalic anhydride (MTHPA). The curing agent is used to trigger a crosslink reaction with the curable resin at 150˜250° C.

### EXPERIMENTAL EXAMPLE

Acetone and butanone are mixed in a ratio of 3:7 to form a mixed solvent, and at the same time, benzoxazine is mixed with the mixed solvent in a ratio of 7:3 to form a benzoxazine/butanone solution. At this time, 8 wt % of polyamide hardener (D-200) and 0.75 wt % of the surface modified nano graphene sheets are added to obtain a composite material solution. The composite material solution is then sealed in a closed container, and stirred up for one hour by a stirrer. Next, the composite material solution is placed into an ultrasonic vibration water bath for a vibration treatment by use of ultrasonic waves for one hour, and heated up to 80-90° C. to remove acetone and butanone so as to obtain the composite material. Further, the composite material is coated on the target object by the processes of coating, immersing and spraying, and subsequently heated up to 200-220° C. to cause the curing agent and the curable resin to crosslink for one hour such that the coating process for the composite material is completed. The drying process is then performed and an additional vacuum process is preferred to remove bubbles possibly contained in the composite material. Therefore, the graphene composite coating layer is finally formed on the target object. Furthermore, a catalyst is added to the composite material solution to speed up the crosslink reaction of the curable resin and the curing agent such that the change in viscosity of the curable resin does not affect the homogeneousness of the surface modified nano graphene sheets 25 spread in the curable mixed resin when the heated crosslink reaction is activated. Specifically, the catalyst is selected from a group consisting of imidazole, N-methylimidazole, 1,2-dimethylimidazole, tetraethylammonium bromide, tetrabutyl ammonium bromide, benzyltriethylammonium chloride, and 2,4,6-tris(dimethylaminomethyl)phenol, and a combination thereof.

It is preferred that the thickness of the graphene composite coating layer 10 is 10-500 μm. For the thickness of 500˜5,000 μm, the tensile stress of the graphene composite coating layer 10 is larger than 60 MPa, the yield strength more than 100 MPa, and the elasticity modulus greater than 2 Gpa.

From the above-mentioned, one aspect of the present invention is that the graphene sheets and the resin are fully mixed and compatible so as to form a homogenous mixture, enhance the junction adhesion and effectively increase the mechanical performance of the composite material layer. As a result, the graphene composite coating layer of the present invention is suitably served as an enhancing coating layer for the target object, thereby enhancing the functions of the target object like anti-oxidation, acid/base resistance and mechanical strength.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A graphene composite coating layer for being coated on a surface of a target object, comprising:
a curable mixed resin being more than 97 wt % of the graphene composite coating layer and comprising a curable resin and a curing agent, wherein the curable resin is 10-50 wt % of the curable mixed resin, and the curing agent is 0˜10 wt % of the curable mixed resin; and
a plurality of surface modified nano graphene sheets being less than 3 wt % of the graphene composite coating layer and evenly spread in the curable mixed resin with a distribution density of 0.001˜0.05 g/cm³, wherein the surface modified nano graphene sheet has a modified surface with specific functional groups, comprising at least one of —SO₃, —R′COX, —R′(COOH)₂, —R′COOH, —R′CH₂X—OH and —R′CHO, R′ is alkyl, and X is —NH₂ and/or OH.

2. The graphene composite coating layer as claimed in claim 1, further comprising an oxygen content of 3-20 wt %.

3. The graphene composite coating layer as claimed in claim 1, wherein the curable resin comprises at least one of epoxy resin, polybenzoxazine, polyurethane resin, polysiloxane, phenoic resin, acrylic resin, urea formaldehyde resin and polyester.

4. The graphene composite coating layer as claimed in claim 1, wherein the curing agent comprises at least one of diethylmethylbenzenediamine (DETDA), polyamide hardener, peptide, aliphatic amine epoxy hardener, methylhexahydrophthalic anhydride (MHHPA) and methyltetrahydrophthalic anhydride (MTHPA).

5. The graphene composite coating layer as claimed in claim 1, wherein the curable resin and the curing agent are processed by a crosslink reaction at a temperature of 150˜250° C.

6. The graphene composite coating layer as claimed in claim 5, further comprising a catalyst for speeding up the crosslink reaction.

7. The graphene composite coating layer as claimed in claim 6, wherein the catalyst is selected from a group consisting of imidazole, N-methylimidazole, 1,2-dimethylimidazole, tetraethylammonium bromide, tetrabutyl ammonium bromide, benzyltriethylammonium chloride, and 2,4,6-tris(dimethylaminomethyl)phenol, and a combination thereof.
